(19) United States
(12) Patent Application Publication
(10) Pub. No.: US 2004/0047599 A1
(43) Pub. Date: Mar. 11, 2004

(54) Methods and systems for remotely accessing a digital television terminal via a global communication network

(75) Inventor: Richard S. Grzeczkowski, Warrington, PA (US)

Correspondence Address: LAW OFFICE OF BARRY R LIPSITZ, 755 MAIN STREET, MONROE, CT, 06468, US

(73) Assignee: General Instrument Corporation, Horsham, PA (US)

(21) Appl. No.: 10/236,574

(22) Filed: Sep. 5, 2002

(51) Int. Cl. H04N 5/76; G06F 3/00; G06F 13/00

(52) U.S. Cl. 386/83; 725/58

(57) ABSTRACT

The present invention provides methods and systems for remotely accessing a digital television terminal via a global communication network. In one example embodiment, a remote device adapted for connection to the digital television terminal via a global communication network is provided. An interface which is downloadable to the remote device via the global communication network enables the remote device to communicate with the digital television terminal. Once the interface is downloaded, the remote device is enabled to remotely access and control the digital television terminal.

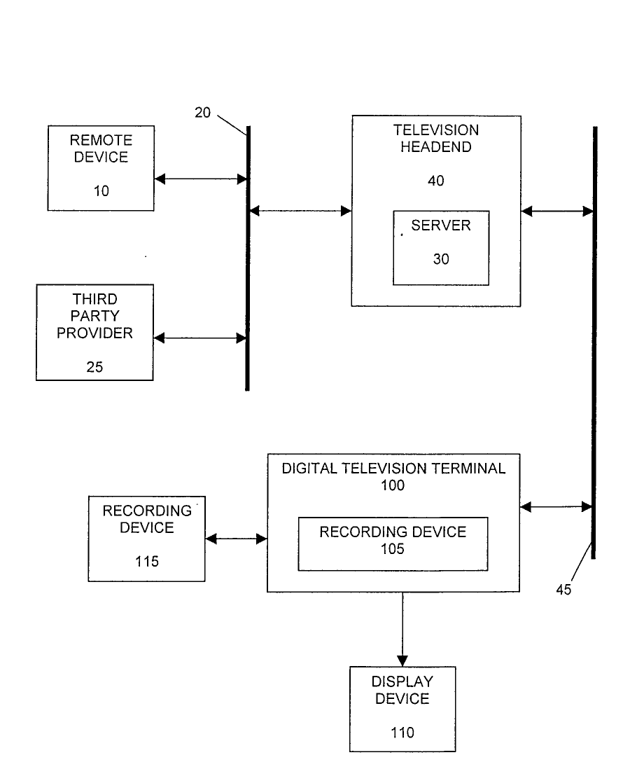

### BACKGROUND OF THE INVENTION

The present invention relates to the field of digital television. More specifically, the present invention relates to methods and systems for remotely accessing a digital television terminal via a global communication network.

As digital television systems continue to develop, more and more features are being added to the digital television terminal, such as pay-per-view, electronic program guides, digital video recording capabilities, video-on-demand, weather and stock information, as well as Internet access and related features.

To date, these features may only be controlled by a user interacting directly with the digital television terminal. For example, a user must remember to program a digital video recorder (either included in or associated with the digital television terminal) before leaving home in order to record a program while the user is away from home.

It would be advantageous to enable control of the digital television terminal from a remote location. It would be further advantageous to enable control of a digital television terminal from a remote device via a global communication network. It would also be advantageous to provide control of a recording device associated with the digital television terminal via a remote device.

The methods and systems of the present invention provide the foregoing and other advantages.

### SUMMARY OF THE INVENTION

The present invention relates to remote access and control of a digital television terminal via a global communication network. In particular, the present invention provides methods and systems for remotely accessing a digital television terminal via a global communication network. In one example embodiment, a remote device adapted for connection to the digital television terminal via a global communication network is provided. An interface which is downloadable to the remote device via the global communication network enables the remote device to communicate with the digital television terminal. Once the interface is downloaded, the remote device is enabled to remotely access and control the digital television terminal.

### BRIEF DESCRIPTION OF THE DRAWINGS

The present invention will hereinafter be described in conjunction with the appended drawing FIGURE. The FIGURE shows a block diagram of an example embodiment of the invention.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

The present invention provides methods and systems for remotely accessing a digital television terminal via a global communication network. In one example embodiment as shown in the FIGURE, a remote device 10 adapted for connection to the digital television terminal 100 via a global communication network 20 is provided. An interface (e.g., a software program) which is downloadable to the remote device 10 via the global communication network 20 enables the remote device 10 to communicate with the digital television terminal 100. Once the interface is downloaded, the remote device 10 is enabled to remotely access the digital television terminal 100.

Those skilled in the art will appreciate that the digital television terminal 100 shown in the FIGURE is one of a family of terminals in the television network. Further, the digital television terminal 100 may be a stand-alone device or may be integrated into a digital television or a personal computer.

The remote device 10 may comprise one of a personal computer, a personal digital assistant, an Internet appliance, a cellular telephone, or similar device. Those skilled in the art will appreciate that the same digital television terminal 100 may be accessed and controlled by one or more remote devices 10. For example, a user may be able to log onto an online account via a remote device 10 at work by entering a password to gain access to the digital television terminal 100. The same user may also be able to log into the online account via a different remote device 10 located at another location by entering the password. In other words, a single remote device 10 does not necessarily control a single digital television terminal 100, and access to the digital television terminal may be password controlled so that a user can conveniently access the user's account from any device connected to the global communication network 20, so long as the device is capable of downloading the required interface.

The digital television terminal 100 may be remotely programmed to record a program. The digital television terminal 100 may comprise a digital video recording device 105, which may be programmed via the remote device 10. Alternatively, the program may recorded on a recording device 115, such as a VCR or digital video recorder, associated with the digital television terminal 115. In such an embodiment, the recording device 115 may be programmed via the digital television terminal 100, which in turn may be controlled by the remote device 10.

In a further example embodiment, the digital television terminal 100 may be remotely programmed to provide reminders for start times of desired programs. For example, such programmed reminders may appear on the display device 110 (e.g., a television screen, computer screen, or the like) at the programmed time (e.g., 15 minutes before the desired program start time).

A server 30 may be provided between the global communication network 20 and a television network 45 to enable the connection between the remote device 10 and the digital television terminal 100. The server 30 may be located at a television system headend 40.

In a further example embodiment, the remote device 10 may be enabled for sending messages to the digital television terminal 100 for display on an associated display device 110. For example, a user at a remote location would be able to send a message to the digital television terminal 100 for display for viewing by a second user at the television.

The present invention enables additional features which may be controlled remotely. For example, parental control parameters of the digital television terminal 100 may be remotely programmed. Service may be remotely requested from a headend system operator for the digital television terminal 100 (or any other portion of the television system).

In addition, access to a user's television account information may be provided via the remote device 10. The account may be modified via the remote device 10. The modifications may include, for example, at least one of paying an account balance, changing programming options, canceling services, terminating the account, and similar modifications.

In a further example embodiment, a command may be sent from the remote device 10 to the digital television terminal 100. Once the command is received by the digital television terminal 100, a reply may then be sent from the digital television terminal 100 to the remote device 10 acknowledging receipt of the command. The command may comprise one of a record program command, a program reminder command, a parental control command, or other configuration and control commands for the digital television terminal 100.

The interface may be downloadable from a television system headend 40. Alternatively, the interface may be downloadable from a third party provider 25 via the global communication network.

It should now be appreciated that the present invention provides advantageous methods and apparatus for accessing and controlling a digital television terminal from a remote location via a global communication network.

Although the invention has been described in connection with various illustrated embodiments, numerous modifications and adaptations may be made thereto without departing from the spirit and scope of the invention as set forth in the claims.

What is claimed is:

1. A method for remotely accessing a digital television terminal via a global communication network, comprising the steps of:
establishing a connection over the global communication network between a remote device and the digital television terminal;
downloading an interface to the remote device to enable communication with the digital television terminal; and
remotely accessing the television terminal via the remote device.

2. A method in accordance with claim 1, wherein said remote device comprises one of a personal computer, a personal digital assistant, an Internet appliance, or a cellular telephone.

3. A method in accordance with claim 1, further comprising remotely programming the digital television terminal to record a program.

4. A method in accordance with claim 3, wherein the digital television terminal comprises a digital video recording device.

5. A method in accordance with claim 3, wherein the program is recorded on a recording device associated with the digital television terminal.

6. A method in accordance with claim 1, further comprising remotely programming the digital television terminal to provide reminders for start times of desired programs.

7. A method in accordance with claim 1, further comprising providing a server between the global communication network and a television network to enable said connection between the remote device and the digital television terminal.

8. A method in accordance with claim 7, wherein said server is located at a television system headend.

9. A method in accordance with claim 1, further comprising sending messages from the remote device to the digital television terminal for display on an associated display device.

10. A method in accordance with claim 1, further comprising remotely programming parental control parameters of the digital television terminal.

11. A method in accordance with claim 1, further comprising remotely requesting service from a system operator for said digital television terminal.

12. A method in accordance with claim 1, further comprising providing access to a user's television account information via said remote device.

13. A method in accordance with claim 12, further comprising enabling modifications to said account via said remote device.

14. A method in accordance with claim 13, wherein said modifications include at least one of paying an account balance, changing programming options, canceling services, or terminating the account.

15. A method in accordance with claim 1, further comprising:
sending a command from the remote device to the digital television terminal; and
sending a reply from the digital television terminal to the remote device acknowledging receipt of the command.

16. A method in accordance with claim 15, wherein said command comprises one of a record program command, a program reminder command, or a parental control command.

17. A method in accordance with claim 1, wherein said interface is downloadable from a television system headend.

18. A method in accordance with claim 1, wherein said interface is downloadable from a third party provider via the global communication network

19. A system for remotely accessing a digital television terminal, comprising:
a remote device adapted for connection to the digital television terminal via a global communication network; and
an interface downloadable to the remote device via the global communication network to enable the remote device to communicate with the digital television terminal; wherein:
the remote device is enabled to remotely access the digital television terminal.

20. A system in accordance with claim 19, wherein said remote device comprises one of a personal computer, a personal digital assistant, an Internet appliance, or a cellular telephone.

21. A system in accordance with claim 19, wherein said digital television terminal is remotely programmed to record a program.

22. A system in accordance with claim 21, wherein said digital television terminal comprises a digital video recording device.

23. A system in accordance with claim 21, wherein the program is recorded on a recording device associated with the digital television terminal.

24. A system in accordance with claim 19, wherein the digital television terminal is remotely programmed to provide reminders for start times of desired programs.

25. A system in accordance with claim 19, further comprising a server between the global communication network and a television network to enable the connection between the remote device and the digital television terminal.

26. A system in accordance with claim 25, wherein said server is located at a television system headend.

27. A system in accordance with claim 19, wherein the remote device is enabled for sending messages to the digital television terminal for display on an associated display device.

28. A system in accordance with claim 19, wherein parental control parameters of the digital television terminal are remotely programmed.

29. A system in accordance with claim 19, wherein service is remotely requested from a system operator for said digital television terminal.

30. A system in accordance with claim 19, wherein access to a user's television account information is provided via said remote device.

31. A system in accordance with claim 30, wherein said account is modified via said remote device.

32. A system in accordance with claim 31, wherein said modifications include at least one of paying an account balance, changing programming options, canceling services, or terminating the account.

33. A system in accordance with claim 19, wherein:
a command is sent from the remote device to the digital television terminal; and
a reply is sent from the digital television terminal to the remote device acknowledging receipt of the command.

34. A system in accordance with claim 33, wherein said command comprises one of a record program command, a program reminder command, or a parental control command.

35. A system in accordance with claim 19, wherein said interface is downloadable from a television system headend.

36. A system in accordance with claim 19, wherein said interface is downloadable from a third party provider via the global communication network.
